(19) United States
(12) Patent Application Publication
(10) Pub. No.: US 2018/0033049 A1
(43) Pub. Date: Feb. 1, 2018

(54) DISTRIBUTED ADVERTISING SYSTEM AND METHOD OF USE

(71) Applicants: Walter G. Mayfield, Houston, TX (US); Richard A. WINLEY III, Houston, TX (US)

(72) Inventors: Walter G. Mayfield, Houston, TX (US); Richard A. WINLEY III, Houston, TX (US)

(21) Appl. No.: 15/516,348

(22) PCT Filed: Oct. 1, 2015
(86) PCT No.: PCT/US2015/053567

§ 371 Date: Mar. 31, 2017

Related U.S. Application Data
(60) Provisional application No. 62/058,493, filed on Oct. 1, 2014.
(60) Provisional application No. 62/063,079, filed on Oct. 13, 2014.
(60) Provisional application No. 62/104,299, filed on Jan. 16, 2015.
(60) Provisional application No. 62/104,424, filed on Jan. 16, 2015.
(60) Provisional application No. 62/133,070, filed on Mar. 13, 2015.
(60) Provisional application No. 62/133,078, filed on Mar. 13, 2015.
(60) Provisional application No. 62/137,001, filed on Mar. 23, 2015.
(60) Provisional application No. 62/137,010, filed on Mar. 23, 2015.
(60) Provisional application No. 62/159,049, filed on May 8, 2015.
(60) Provisional application No. 62/159,018, filed on May 8, 2015.

(51) Int. Cl. G06Q 30/02; G09F 21/04; G09F 9/30; G09F 21/02

(52) U.S. Cl. CPC G06Q 30/0265; G09F 21/026; G09F 21/04; G09F 9/30

(57) ABSTRACT

Distributed advertising can be accomplished employing systems that include a fixed display device, and a controller. Such a system can then communicate its location to a controller which in turn can then download to the display device advertising content. Display device owners can be compensated for their efforts based, at least in part, upon the effectiveness of the advertisements as determined by the number of viewers passing the display device.

### TECHNICAL FIELD

The present invention relates to a system useful for distributed advertising. The present invention particularly relates to such a system wherein the advertising content is delivered using a fixed display.

### BACKGROUND

Currently, Internet usage, and particularly that of the World Wide Web (henceforth referred to as simply the “web”), is growing explosively, particularly as the number of web sites and users that have access to the Internet continue to rapidly , perhaps even exponentially, expand. Such advertising, though no doubt valuable, is not without its drawbacks.

For example, “click” advertising, while useful, necessarily requires that a great number of potential consumers see advertisements before there is a conjunction between the advertisement and a consumer who needs the services. Stated another way, this kind of advertising requires the casting of a great number of advertisements to the winds in the hopes of an interested buyer receiving.

It would be desirable in the art of advertising to be able to selectively advertise goods and services using fixed advertising assets while generating a comparatively large number interested buyer/advertisement interactions.

### SUMMARY

In one aspect, the invention is a system for distributed advertising comprising: a fixed display device, and a controller, wherein: the fixed display device is in communication with the controller, and the display device, or associated device, is configured to display advertising upon command from the controller.

In another aspect, the invention is a method of distributed advertising comprising: wirelessly establishing communication between a fixed display device and a controller wherein: the fixed display device uploads its location to the controller; and the controller, based upon the location of the display device, transmits to the display device advertising content.

### DETAILED DESCRIPTION

In one embodiment, the invention is a system for distributed advertising comprising: a fixed display device, and a controller, wherein: the display device is in communication with the controller, the display device is fixed, the display device, or an associated device is able to receive and interpret a GPS signal or other signal which can be used to ascertain the location of the display device, and the display device, or associated device, is configured to display advertising upon command from the controller.

For the purposes of this invention, the term “distributed advertising” means advertising which is made available to the public using fixed displays wherein the material advertised is selected on the basis of the location of the display device.

In the system of the application, the “display device” may be an iPad or other tablet computer, other computer of other types, and any other device having a display of any size. In another embodiment, the display device may be a monitor being controlled by a computer or a smart phone. In another embodiment, the display device would be a projector which projects advertising content upon a surface such as a wall, screen, window, and even a cloud of vapor or smoke. In one particularly useful embodiment, a display device could be a conventional large advertising sign, such as those alongside a roadway, which has been retrofitted using a large pixilated display.

For purposes of the present application, the term controller means a server on the web, a standalone computer which may or may not be connected to the web; but is equipped to communicate wirelessly using Wi-Fi, Bluetooth, and the like.

The display devices used for advertising are fixed. This means that they are not readily transportable. For example, a large advertising sign concreted in the ground is a fixed display device.

In the system of the application, the display device maybe configured to be wirelessly connected to the server. Ways in which this can be achieved include but are not limited to, a mobile data system such as those used with cell phones, Wi-Fi, Bluetooth, and the like.

Where a display device requires an associated device to be wirelessly connected to the controller, the combination of these 2 devices shall be treated as a single device hereinafter in this application.

The display device may include a GPS receiver, or other component which allows the display device to ascertain its current location with sufficient accuracy in regards to geography to be useful in real time advertising. This is particularly useful for fixed display devices which are transportable (as opposed to readily transportable).

The controller is employed within the systems of the application are configured to download advertising information or data to display devices.

The display devices (possibly in combination with associated devices) may further include a compass, motion detector, camera, sensors to determine the orientation of the display device, and any other component which would facilitate advertising. Such components include those which would facilitate determinations of the number of pedestrians or drivers viewing the advertising information or data.

In one embodiment, the display device may be configured to operate with other display devices. For example, in one embodiment, the display device may actually be 3 display devices, connected together via software, to display a single message or allow a message which is shorter than one or 2 display devices to be displayed as moving across all three.

In some embodiments of the practice of the method of the application, the display device transmits to the controller its location. In one embodiment, the controller then can download advertising information or data (such as but not limited to photographs, drawings, and graphs) selected to be relevant to a vendor or service provider in near geographic proximity. For the purposes of this application, the term “advertiser” means a vendor or service provider who is a subscriber to use a system of the application for advertising purposes.

Advertisers may select the size of the geographic area in which their advertisements will be displayed. That size will be a function of the type of advertiser, or rather the goods or services provided by the advertiser, and these speed and velocity of the display device.

The fixed display devices useful with the methods of this application may include components which can be employed to make determinations of quantity and quality of traffic (both pedestrian and vehicular) in its vicinity. One such device which could be used to assist in this determination would be a camera. Another such device would be a motion detector. While not a device, where the display device is proximate to a motorway, traffic reporting services could also be used to estimate the number of viewers for the advertising content.

One aspect of the method of the application is that the system of the application would be employed to reward display device owners for effecting advertisements. In one embodiment of the method of the application, the display device owner would be paid based on the number of viewers of the advertising content.

In addition to being used to reward the display device owners, the system of the application can be used to provide reports to advertisers. For example, in one embodiment, a report could be generated for the advertiser which would disclose the number of advertisements made within a specified area, the number of viewers of the advertised content, and the dates and times that those viewings occurred.

In one desirable embodiment of the method of the application, proximity of the display device to the nearest and furtherest viewers can be used to select both the advertising content and its size on the display device. For example, where viewers are further away, or the velocity differential between the display device and the viewer is high, then necessarily the advertising content will need to be comparatively large. An exemplary situation would be where a motorcyclist or bicyclist is being quickly passing by a display device.

In contrast, another desirable embodiment of the method of the application would be a situation where a display device is fixed in a mall. The velocity differential would be the velocity of the viewers. In this situation, the size of the advertising content could be comparatively small since the viewer would have a longer time to view the advertisement.

In some embodiments, the controller could be employed to make changes to the settings of the display device. For example, where the display device is being employed the controller can adjust the brightness of the display device to be effective relative to the ambient light conditions. In still another embodiment, a microphone in the display device could be employed to determine the level of ambient noise and then adjust the speaker volume of the display device for advertisements that have an audio component.

In an alternative embodiment, the controller may be a device located within a specific store within a mall, somewhat analogous to an iBeacon, wherein the device within the store transmits to the display device the advertising content in the proximity in which it is to be displayed. For example, a vendor within a mall could connect to a system of the application and specify advertisements to be shown within 50 feet of his storefront.

The display devices employed with the methods of the application will include components that allow for the verification and quantification of the display device owners' advertising efforts. For example, if a camera in the display device is accessed and does not show any viewers, in at least some embodiments, the display device owner would not be paid.

In situations where a display device owner desires to restrict the type of advertising that he is willing to have displayed on his display device, advertisements can be grouped by type. For example, advertising could be grouped by: “green” advertising; adult advertising; non-vegetarian advertising; and the like. Once a menu of advertisers or types of advertising is generated, display device owners would be allowed to select or exclude advertisements or advertisers from the menu.

In another embodiment of the application, display device owners can be solicited using the Internet.

The distributed advertising systems of the application may be employed in such a way that display device owners are paid for their efforts. One advantage of the systems of the application is that they may be selected based on their proximity to a specific vendor or other location. In one embodiment, the systems of the application are employed using a business plan where advertiser offers to pay display device owners varying rates. For example, in one such embodiment, an advertiser may elect to offer a rate of $5 to display device owners within 1 km of their establishment; $3 to display device owners within 5 km but outside of 1 km; and a standard rate of $1 for display device owners more than 5 km from their establishment.

In an alternative embodiment, rather than rates being based upon proximity to a retail establishment, the rates may be rather tied to their proximity to an event. For example, display device owners having displaced fixed at an event such as a festival, and the like; may be deemed by certain advertisers to be especially valuable and alternative rates offered for that general location during the period of the event/festival. Just as in conventional advertising, the rates may be based upon the size, type, and location of the display device.

One issue advertisers may face is the possibility that there may be too many display devices in a given area. If they were to advertise on all the fixed display devices they may actually over saturate the area with advertising. In some instances, this has been known to have a negative effect upon consumers! There are several solutions to this issue which may be employed in some embodiments of the methods of the application.

One such solution would be to allow a fixed number of fixed displays to display the advertisements on a first-come first-served basis. In an alternative embodiment of the solution, the advertisers may put it up for bids. In this embodiment, the advertisers would make “jobs” available to display device owners, offering the work at an escalating rate with the jobs accepted by the display device owners by bidding until all available positions are taken.

In situations where there is an excess of display devices in a given geographical area or where display devices are only partially utilized via conventional advertising, the system of the application may be employed to allow the display device owners to fill the gaps and fully utilized their assets.

In still another embodiment, the advertisers may be able to select from a group of “elite” display device owners. The status of a display device owner could be determined based upon their general availability, effectiveness based upon how many people (pedestrians and/or drivers) see their advertising content wherein that determination is made using a camera or other proximity sensing device.

In one very unique embodiment of the method of the application, advertising content can be distributed to multiple display device owners such that a part of the advertisement is sent to each display device owner. This is somewhat analogous to the old Burma-Shave signs. In the mid-20^{th} century, a manufacturer of shaving cream would put a series of signs along the highway at a fixed interval. Each sign would require the driver to see the next sign and the next sign in order to get the full content of the message. In one embodiment of this method of the application, a 10 word advertisement could be displayed on 10 individual display device owners' displays. In yet another alternative embodiment, the same 10 display device owners could spell out a single 10 letter advertisement. This would be particularly effective at events where stadium seating would be available so that the words and/or letters could also be arranged spatially to add emphasis to the message.

In embodiments of the methods of the application where the display devices are capable of accepting input, then advertisements may be displayed that would allow input by people observing them. One such advertisement would be a survey. Exemplary of such an advertisement would be a survey for the observer's preference for a political party, a commercial product, or the like. In practice, the advertisement or displayed on the display device and input would be invited using an input device. Where the display device is a tablet computer, then a person observing the advertisement could touch on a radio button, or other input on a touch screen.

A more specialized display device could be used where the specialized display device would be configured to interface with one or more input devices such as a game controller or a keypad or a joystick. This would be particularly useful where a longer survey was involved. An exemplary method were such a device could be employed would be one where a display device displayed an invitation to people observing to take part in a survey, and once an observer indicated interest, they would be allowed an input device to input data into the survey directly on the display device.

In addition to surveys, similar methods could be employed where people observing the advertisements could provide contact information to receive coupons or other incentives. These could be in the form of coupon codes that can be offered to a retailer for discount. In an alternative embodiment this could be in the form of actual coupons made available by the display device owner, perhaps by use of some type of automatic dispenser. In still another embodiment, the coupons could be made available by displaying on the display device a link for an observer to access to digital or printable coupons. Of course, a displayed coupon can always be photographed by an observer and the photographed used to redeemed the coupon for good or services at the subject retailers, including e-retailers. For example, a coupon including a QR code could be displayed.

Another embodiment of the method of the application is pro bono advertising. For example a potential display device owner could be incentivized to become display device owner using the methods of the application if he were able to promote issues or products that were of interest to him during periods where he was not being actively paid by an advertiser.

The systems of the application can desirably include components which will facilitate evaluating display device owners. As already discussed, most display devices contemplated will have a camera, speaker, microphone, and an optional GPS receiver. Also, in some embodiments it would be useful if the display devices were to include Bluetooth transceivers, Wi-Fi transceivers, and spatial sensors. All of this equipment can be employed to ensure that the display device owners are living up to their obligations to the advertisers. This would both prevent fraud and allow the “elite” display device owners to be recognized.

The systems of the application can be employed for positive social purposes. Exemplary of this would be situations where pro bono advertisements were placed for museums, charities, and the like. Similarly, the systems of the application could be made accessible to civil authorities for important announcements such as tornado warnings, Amber alerts, and shelter in place announcements.

The systems of the application could be employed to strategically locate advertising relating to a lobbyist effort. For example, where an individual or a group wanted to influence a legislator regarding the passage of a bill relating to school finance, the advertisements necessary to do so could be displayed on display devices proximate to a state capital or, with sufficient intelligence, along the traffic routes of the legislators.

Finally, the fixed display advertising systems of the application may be used to take electronic payments for sale and delivery of product, services, or nonprofit causes. For example, Apple Pay™, a mobile device swipe card reader, or other electronic device, directly or wirelessly connected to the system may be used to transact a sale. The fixed display advertising systems may incorporate an manual input device to allow a purchaser to input credit card and delivery information. In another embodiment, the credit card and or delivery information could be inputted using an application running on a cellular phone or other portable device.

Any method and/or device useful for conducting a remote or automatic sale known to those of ordinary skill in the art may be employed with the fixed display advertising systems of the application. In such an embodiment, the fixed display advertising system may email or even text an entity selling goods and/or services, such as Amazon™, the information necessary to complete a transaction. In the alternative, the fixed display advertising system may communicate to a purchaser a sellers specific item information or even the sellers general website, and then allow the purchaser a chance to complete the purchase on their own. In still another embodiment, this information may be retained by the system for future reference and/or distribution. Such embodiments would allow any fixed display advertising system of the application to connect with any seller in the world to advertise a product in most any location at any time and conduct an immediate sale.

Taking this concept even further, advertising may be made even more personalized towards a particular “customer”. For example, if a customer frequents certain locations then customize advertisement for those locations can be displayed. In the case of a clothing store, advertisements relating to that particular store or even a competitor could be displayed.

Going yet another step farther, information gathered on any particular client could be retained for future use. Exemplary of this would be a situation where the fact that a client gambles at a particular casino or purchases certain luxury or upscale merchandise; that situation could be the basis for generating advertisement for completely different goods that are often bought by people purchasing items at that particular customer has historically purchased.

The method and systems of the application can include software which can be downloaded for use on a portable device. This software can be used to interact with advertising devices for additional functionality. Exemplary of this would be an instance where advertisement for a restaurant or by a service such as OPEN TABLE™ was on display and a user could interact with the display device to make a reservation. Also, the software could be used to collect data from the downloader and then utilized by the display device to tailor advertising or the delivery of other content.

While primarily being directed to the delivery of information in the form of advertising, the systems and devices of the application may be employed to deliver other content. Such content includes, but is not limited to: books and other documents, entertainment such as streaming video, and the like.

While the term “retailer” has been used to describe those who might employ the methods and systems of the application, the systems and methods of the application may be employed by any kind of merchant as well as those that are attempting to communicate information relating to politics or policy or any other type of non-commercial speech. For example, in addition to merchants selling clothing, the systems and methods of the application may be employed by food sellers (such a Pizzerias), political candidates, and even pollsters.

What is claimed is:

1. A system for distributed advertising comprising:
a fixed display device, and
a controller,
wherein:
the display device is in communication with the controller,
the display device is fixed, and
the display device, or associated device, is configured to display advertising upon command from the controller.

2. The system of claim 1 wherein the display device is selected from the group consisting of: an iPad or other tablet computer, a monitor being controlled by a computer or a smart phone, a projector which projects advertising content upon a surface such as a wall, screen, window, and even a cloud of vapor or smoke, and a conventional large advertising sign which has been retrofitted using a large pixilated display.

3. The system of claim 1 further comprising an element selected from the group consisting of a compass, motion detector, camera, sensors to determine the orientation of the display device, and combinations thereof.

4. The system of claim 1 wherein the display device further comprises a joystick.

5. The system of claim 1 wherein the display device further comprises a keyboard accessible to consumers.

6. A method of distributed advertising comprising wirelessly establishing communication between a fixed display device and a controller wherein:
the display device or an associated device will upload its location to the controller; and
the controller, based upon the location of the display device, transmits to the display device advertising content.

7. The method of claim 6 wherein the advertising content is selected based upon the location of the display device.

8. The method of claim 6 wherein advertisers may select a size of a geographic area in which their advertisements are displayed.

9. The method of claim 6 wherein a display device owner are rewarded for effective advertisements.

10. The method of claim 6 wherein proximity of the display device to the nearest and furtherest viewers can be used to select both the advertising content and its size on the display device.

11. The method of claim 6 wherein a single advertisement is segmented among more than one display device.
